(19) United States
(12) Patent Application Publication
(10) Pub. No.: US 2007/0100749 A1
(43) Pub. Date: May 3, 2007

(54) Online bill payment management and projected account balances

(76) Inventors: Deepa Bachu, Union City, CA (US); Tara Feldmeier, Palo Alto, CA (US); Craig LaSalle, Los Altos, CA (US); Suzanne Y. Pellican, Menlo Park, CA (US); Steven A. Sholtis, El Dorado Hills, CA (US); Wendy Spies, San Mateo, CA (US); Jeffrey P. Zimmerman, Menlo Park, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/262,305

(22) Filed: Oct. 28, 2005

(51) Int. Cl. G06Q 40/00

(52) U.S. Cl. 705/42; 705/35

(57) ABSTRACT

User-entered transactions, not yet recorded or processed by a financial institution, transactions generated by the user in other systems such as biller direct websites or presented bills, and transactions received from the financial institution are combined so as to develop and display projected balances at a banking website. Projected balances take into account manually-entered information combined with information for transactions that have already been processed by the financial institution, so as to provide accurate projected balances.

### CROSS-REFERENCE TO RELATED APPLICATIONS

The present invention is related to U.S. Utility patent application Ser. No. 10/769,277, for “Payables Manager,” filed Jan. 30, 2004, the disclosure of which is incorporated herein by reference.

The present invention is related to U.S. Utility patent application Ser. No. ______, for “Calendar and Running Balance for Billpay Planning”, inventor Suzanne Y. Pellican, filed _{——————}, the disclosure of which is incorporated herein by reference.

The present invention is related to U.S. Utility patent application Ser. No. 10/997,157, for “Monthly Transactions View”, filed Nov. 24, 2004, the disclosure of which is incorporated herein by reference.

### BACKGROUND

The present invention relates to online tools for management of account balance and bill payment operations.

Personal online banking is well known. A description of such technology and functionality appears, for example in U.S. Pat. No. 5,903,881, issued May 11, 1999 to Schrader, et al. for “Personal online banking with integrated online statement and checkbook user interface.” Users of online banking sites often perform a number of tasks at such sites, including initiating and verifying bill payment activities. Some users also use such sites for checking bank balances, verifying that certain transactions have taken place, and transferring money from one account to another.

Banking websites are, in general, able to provide information as to account balance, including transactions that have been processed by the bank. These account balances do not, in general, take into account future bills and other transactions that have not yet been processed by the bank. In order to accurately project their balances and bill-paying ability into the future, users are required to maintain a separate transaction record, either manually or in a personal financial software application such as Intuit Quicken or Microsoft Money. This separate transaction record can be updated to include downloaded transactions as well as manually-entered transactions, and can take into account expected future bills (including recurring bills). Unlike the separate transaction record maintained locally by the user, in general, the transaction information at the banking website does not include information about future bills (including recurring bills) and other transactions that have not yet been processed by the bank. Accordingly, there is no single place where the user can see accurate balance projections that include both user-entered transactions and bank-processed transactions at banking website.

### SUMMARY

In various embodiments, the present invention provides methods and systems for including expected bills in projected balances at a website associated with a bank or other financial institution. The user can manually enter bills, including those that have not yet been processed by the financial institution and are therefore not yet available to the financial institution website. These bills can include, for example, recurring bills, whether such bills have fixed or variable amounts. For bills having variable amounts, an estimate can be provided. The user can also manually enter transactions (and recurring transactions), including those that have not yet been processed by the financial institution. According to the techniques described herein, the invention presents to the user projected balances that take into account such manually-entered information combined with information for transactions that have already been processed by the financial institution. The combination of user-entered and financial institution processed transaction data, including expected future bills that may or may not be known to the financial institution, provides the user with a more accurate assessment of his or her bill-paying capability and ongoing expected balance. Such information allows the user to manage bill payment more effectively, by for example setting up future transactions so that expected balances can cover expected bill payments. It also allows the user to 1) review the impact on his or her balance of paying bills on various days and with various dollar amounts, and 2) see where he or she will have excess cash or shortfalls so that he or she can more effectively manage excess cash by, for example, moving funds to or from other accounts.

The present invention thus provides a mechanism for accurately projecting cash flow within a banking website, by including user-entered transaction data and system-entered electronic data from financial institutions and other sources. In various aspects, therefore, the present invention facilitates cash and online bill paying management using any combination of user-entered pending transactions, pending balances, user-entered data appended to transactions, transactions categorization, and bill payment initiation, modification, and the like.

In one aspect, the present invention is able to extract information from electronically presented bills, and to automatically incorporate such information in future balance estimates. In one aspect, the present invention also provides an interface by which users can view such electronically presented bills via the financial institution website.

In one aspect, the present invention automatically reconciles user-entered or bill pay system generated transactions and bill payments with those received from the financial institution. Matching algorithms detect matches between user-entered transactions, including bills, and bank-processed transactions. Matches are tagged as such, and duplicates are avoided. In one aspect, if automatic reconciliation is not possible (for example, if amounts do not match because the user entered inaccurate estimate), the user is given an opportunity to manually indicate a match.

In one aspect, the present invention presents projected balances on a day-by-day basis within a calendar display that incorporates data obtained from a financial institution, as well as any combination of user-entered transaction data, user-entered bill data, and data extracted (scraped) from bills presented electronically.

In one aspect, the present invention is implemented in a web-based application. A web service is used to return HTML components and/or data as a means of achieving rapid integration into a website, so as to lower integration time and improve efficiency. In another aspect, the invention is implemented in the context of a software application running on a personal computer, handheld device, or other device.

### BRIEF DESCRIPTION OF THE DRAWINGS

FIG. 1 is a block diagram depicting a system architecture for practicing the present invention according to one embodiment.

FIG. 2 is a flowchart depicting a method for practicing the present invention according to one embodiment.

FIG. 3 is a screen shot depicting an example of bill management functionality according to one embodiment.

FIG. 4 is a screen shot depicting an example of an account detail page provided by the present invention according to one embodiment.

FIG. 5 is a screen shot depicting a calendar displaying information for more than one account, according to one embodiment.

FIG. 6 is a screen shot depicting a calendar displaying information for more than one account, according to one embodiment.

FIG. 7 is a screen shot depicting an example of a transaction detail screen for reviewing details of user-entered transactions, according to one embodiment.

FIG. 8 is a screen shot depicting an example of an add pending transactions screen for entering user-entered data, according to one embodiment.

FIG. 9 is a screen shot depicting a calendar displaying account balance information and transaction information, according to one embodiment.

FIG. 10 is a screen shot depicting a calendar displaying account balance information including account balances for dates in the past, according to one embodiment.

FIG. 11 is a screen shot depicting a calendar wherein additional information is shown in a ToolTip-type box, according to one embodiment.

FIG. 12 is a screen shot depicting an example of a reconcile screen for manual matching of user-entered transactions with transactions from a financial institution, according to one embodiment.

FIG. 13 is a screen shot depicting an example of an account activity screen for viewing and managing projected transactions, according to one embodiment.

FIG. 14 is a screen shot depicting an example of a confirmation screen for viewing scheduled payments and user-entered items that have been saved as pending transactions, according to one embodiment.

FIG. 15A is a screen shot depicting an example of a screen for adding recurring payments or deposits that were not set up through the financial institution's online bill pay system.

FIG. 15B is a screen shot depicting an example of an add a recurring payment screen for adding recurring payments, according to one embodiment.

FIG. 16 is a screen shot depicting another example of an input screen for entering user-entered data, according to one embodiment.

FIG. 17 is a screen shot depicting an example of a spending history report, according to one embodiment.

FIG. 18 is a screen shot depicting an example of an edit pending transaction screen according to one embodiment.

FIG. 19 is a screen shot depicting an example of a manage electronic bills and deposits screen according to one embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

According to one embodiment, the present invention provides an online tool for assisting users in managing bill payments and determining projected bank account balances. The user is thus able to schedule bill payments and other transactions so as to insure that sufficient funds are available in the bank account to cover expenses. In one embodiment, the online tool uses data received from a financial institution (such as a bank or brokerage), combined with user-entered data and/or data from electronically presented bills. This combination of data provides more accurate projections of account balances, since it takes into account bills and transactions that may not yet be recorded or known to the bank.

By providing users with an accurate picture of their current and projected account balances, taking into account expected and future transactions and bills, the present invention allows users to better manage their funds and to ensure that sufficient funds are present for expected bill payments.

In the following description, the terms “bank”, “brokerage” and “financial institution” are used interchangeably and for illustrative purposes only; one skilled in the art will recognize that transaction data can be received from and/or sent to any entity, including credit card issuers, credit unions, third party processors, banks, and/or other entities. Furthermore, the following description sets forth the present invention in terms of a website containing functionality for entering transaction and bill data; initiating, scheduling, and managing bill payments; viewing reports; and the like. One skilled in the art will recognize, however, that the invention can be practiced in other contexts as well, including within a stand-alone or bundled software application such as a personal financial software application or accounting application. Such a software application can use locally stored data, or can communicate with a remotely located server or other resource associated with or obtaining data from a financial institution. Alternatively, such a software application can use a combination of locally stored data and data received from a remote resource. For example, the functionality described herein can be implemented as a feature of a software application such as Quicken, available from Intuit Inc., which is capable of communicating with financial institutions and bill paying institutions to send and receive transaction information to and from such resources.

Furthermore, the particular arrangements of elements in screen shots and reports shown here are illustrative of one embodiment and are not intended to limit the scope of the present invention.

Architecture

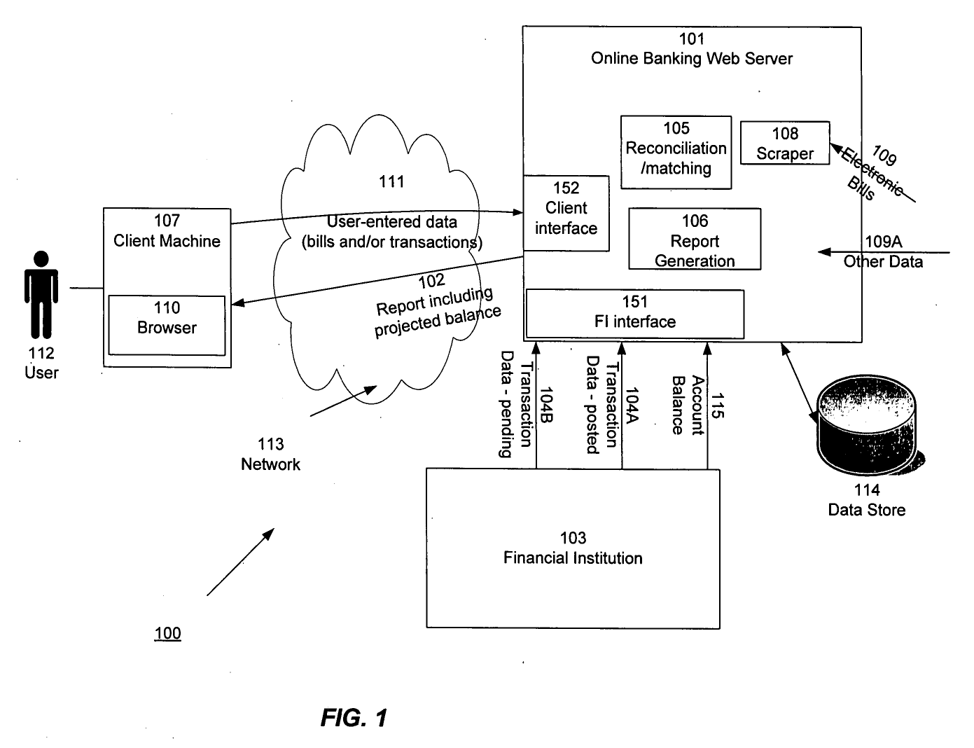

Referring now to FIG. 1, there is shown a block diagram depicting a system 100 for practicing the present invention according to one embodiment. User 112 interacts with online banking web server 101 via client machine 107 running browser 110. In one embodiment, client machine 107 is a computer of conventional design, and includes a processor, an addressable memory, and other conventional features (not illustrated) such as a display, local memory, input/output ports, and a network interface. In other embodiments one or more of the components of client machine 107 may be located remotely and accessed via a network. Client machine 107 interacts with online banking web server 101 via a network such as the Internet 111. In one embodiment, the network interface of client machine 107 performs communication operations to enable such interact via the Internet or some other network such a LAN, a WAN, a MAN, a wired or wireless network, a private network, a virtual private network, or other networks. In various embodiments client machine 107 may be implemented as a computer running a Microsoft operating system, Mac OS, various flavors of Linux, UNIX, Palm OS, and/or other operating systems. In one embodiment, browser 110 running on client machine 107 is a conventional browser, such as Microsoft Internet Explorer or Apple Safari, that facilitates secure interaction with websites.

Online banking web server 101 includes functionality for permitting user 112 to securely access and manage his or her accounts at financial institution 103. Financial institution 103 can be a bank, brokerage, credit union, credit card issuer, or the like. In one embodiment, password protection and authentication, 128-bit encryption, SHTML, and other security features are used to ensure the security of the user's data. Once user 112 has been authenticated, online banking web server 101 obtains transaction data including posted transaction data 104a and/or pending transaction data 104b from financial institution 103, including dates, amounts, and the like, as well as account balance 115. Account balance 115 can be posted, available, pending, and/or projected balance. In one embodiment, only account balance 115 is needed, since account balance 115 incorporates all transactions already known to financial institution 103. In one embodiment, web server 101 comprises a financial institution interface 151 for communicating with financial institutions 103 and a client communication interface 152 for communicating with client machine 107.

As described in more detail below, online banking web server 101 sends HTML code or other presentation technologies to browser 110 causing browser 110 to present a user interface to user 112. The user interface allows the user to enter transactions and/or bills, as well as to review account balances and view transaction information. When user 112 enters transactions and/or bills, the user-entered data 111 is transmitted to online banking web server 101, which projects future balances accordingly. Based on user-entered data 111 along with transaction data 104a, b and/or account balance 115 received from financial institution 103, report generation module 106 presents report 102 including projected balances and other useful information either in the context of HTML web pages or in other formats such as PDF, Microsoft Excel, and the like. In one embodiment, report generation module 106 is replaced by or augmented by a module for generating a list of transactions, or register that may or may not be interactive. This register or other mechanism for presenting transactions and facilitating user 112 interaction with transactions can take the place of report 102 as shown in FIG. 1. Thus, the terms report 102 and report generation module 106 are intended to be illustrative and not limiting. References herein to “report 102” and “report generation module 106” should be considered to encompass such variations as interactive registers and the like.

As described in more detail below, in one embodiment report generation module 106 presents a report 102 including a series of projected balances for various dates in a calendar format. Reports 102 including projected balances are provided to browser 110 in HTML, PDF, Excel, or the like, and displayed to user 112. User 112 can also save and/or print such reports as desired.

Optionally, online banking web server 101 can also include scraper 108 which receives electronic bills 109 and/or other data 109A describing electronic transactions (such as electronic payment screen) addressed to user 112 and extracts amounts and dates from such electronic bills 109 and/or other data 109A. Report generation module 106 uses this extracted data in generating report 102 including projected balances for display to user 112. In one embodiment, scraped bill and deposit information is automatically added to a list of projected transactions, and if relevant, to a list of pending transactions for presentation to the user in accordance with the techniques described herein.

Online banking web server 101 also includes module 105 for reconciling and/or matching user-entered data (and optionally data from electronic bills 109 and/or other data 109A) with transaction data 104a, b received from financial institution 103.

In one embodiment, online banking web server 101 stores user-entered data 111 and/or data extracted by scraper 108 in data store 114 for future use. Upon future visits, data that was previously entered by user 112 or extracted from electronic bills 109 and/or other data 109A is retrieved from data store 114 so that it can be used by report generation module 106 for generating reports and by reconciliation/matching module 105 for reconciling with transaction data 104a, b from financial institution 103. Such data can also be used for transaction look-up, for example to present to the user a list of all transactions for a particular payee in the past year.

One skilled in the art will recognize that the system architecture illustrated in FIG. 1 is merely exemplary, and that the invention may be practiced and implemented using many other architectures and environments.

Method

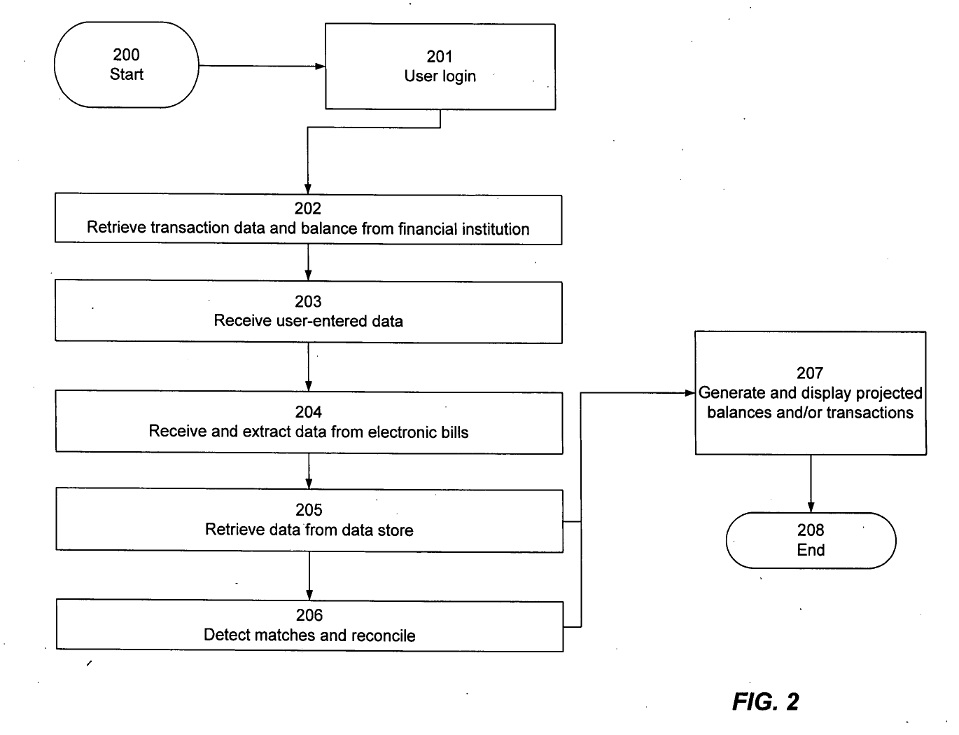

Referring now to FIG. 2, there is shown a flowchart depicting a method for practicing the present invention according to one embodiment. User 112 logs in 201 and is authenticated. Online banking web server 101 retrieves 202 transaction data 104a, b and/or account balance 115 from financial institution 103 and presents a user interface to user 112, including current balances, transactions, and other account information. User 112 is given an opportunity to enter data, including bills and/or future transactions (including recurring and/or nonrecurring transactions). Online banking web server 101 receives 203 this user-entered data 111.

Optionally, scraper 108 receives and extracts 204 data from electronic bills 109 and/or other data 109A as well, so that such data can also be used in generating projected balances and/or displaying transactions and/or displaying presented bills.

Optionally, online banking web server 101 also retrieves 205 data from data store 114. Data from data store 114 may include, for example, user-entered data that was entered during previous visits to the website and/or data received electronically from the FI and/or data extracted from electronic bills during previous online sessions.

Reconciliation/matching module 105 detects 206 matches and duplicates between user-entered data 111 and transaction data 104a, b from financial institution 103; duplicates are deleted. In one embodiment, reconciliation/matching module 105 also detects matches between other types of pending transactions (whether or not they are user-entered) and transaction data 104a, b from financial institution 103. For example, reconciliation/matching module 105 can detect matches between transactions from a biller website, or transactions initiated as electronic bill pay transactions, and transaction data 104a, b. Transaction data can include both pending electronic transactions 104b that financial institution 103 is aware of and that is used for populating the pending transaction list, and posted transactions 104a that are used for reconciliation. In one embodiment, reconciliation/matching module 105 uses matching algorithms that detect inexact matches as well as exact matches. In one embodiment, reconciliation/matching module 105 is also able to perform one-to-many and/or many-to-many transaction reconciliation. In one embodiment, a user interface is provided which allows a user to indicate transaction matches, particularly in situations where reconciliation/matching module 105 is unable to find matches automatically. In one embodiment, the user can be prompted to indicate whether or not a proposed match is correct. Techniques for automated reconciliation are well known in the art.

Report generation module 106 generates and displays 207 report 102 including projected balances and/or transactions. By taking into account user-entered data 111 and data from electronic bills 109 and/or other data 109A, report generation module 106 is able to generate projected balances that take into account transactions and/or bills that are not yet known to financial institution 130; therefore, reports generated by report generation module 106 more accurately reflect user's 112 projected financial situation. Report 102 may be a static report, a dynamic report allowing user interaction, or an input/output screen that allows the user to update, view, modify, and otherwise interact with transaction data.

In one embodiment, user 112 runs a personal financial software application at client machine 107 and enters transactions and/or bills via the software application. In such an embodiment, user-entered data 111 can include data entered via the personal financial software application instead of or in addition to data entered directly at the website presented by online banking web server 101. Thus, user-entered data 111 includes any data entered by the user, whether entered while at the website or entered at some other time. This includes, for example, data entered by the user in a personal financial software application such as Quicken, temporarily stored at the user's computer, and uploaded to online banking web server 101 immediately or at some other point in time.

Report and User Interface

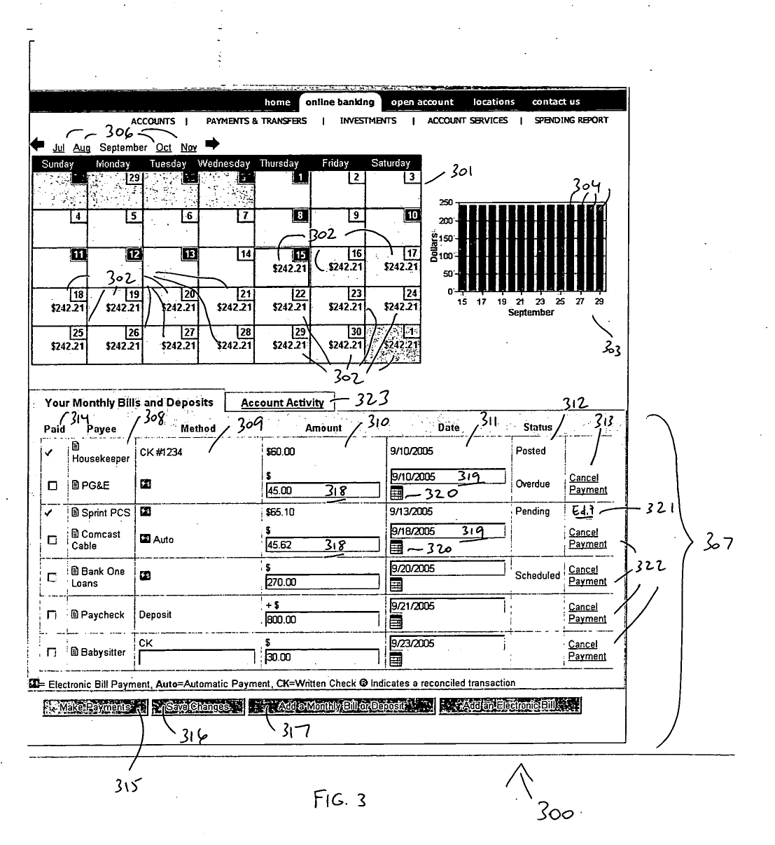

Referring now to FIG. 3, there is shown an example of a report 300 that may be generated by report generation module 106 and presented to user 112 according to the techniques of the present invention. One skilled in the art will recognize that the particular characteristics, layout, and elements of report 300 are presented here for illustrative purposes, and that many variations are possible. Report 300 contains several interactive components allowing for user 112 input; one skilled in the art will recognize that such components can be omitted or modified and that in alternative embodiments report 300 can be noninteractive.

In one embodiment, report 300 includes calendar 301. Calendar 301 includes day-by-day projected account balances 302, which are determined by combining user-entered data 111 with transaction data 104a, b and/or account balance 115 received from financial institution 103, as well as, optionally, data extracted from electronic bills 109 and/or other data 109A. User 112 can navigate to other months by clicking on links 306. Calendar 301 is described in more detail below. Other formats for display of projected account balances may also be used.

In one embodiment, report 300 includes bar graph 303, which visually depicts projected account balances over some period of time using a series of bars 304. For example, bar graph 303 can include an account balance for the current date, plus account balances for 13 additional dates in the future. One skilled in the art will recognize that bar graph 303 can cover any desired period of time. In addition, in one embodiment user 112 can hover a cursor over (or click on) elements of bar graph 303 to see more detailed information.

The financial institution or user 112 can configure report 300 by specifying which elements are included or excluded, for example by clicking on checkbox 305 to hide or show bar graph 303. In one embodiment, the financial institution or user 112 can also specify various parameters and preferences for report 300, including for example which accounts to include, time periods for reports, visual characteristics of reports, and the like. In one embodiment, such parameters and preferences can be set via a preferences screen or page (not shown).

In one embodiment, report 300 includes monthly bills and deposits report 307. Monthly bills and deposits report 307 contains a projected list of anticipated bills and deposits for some period of time, such as for example the current month.

In one embodiment, items appear on this list if, for example, the user has set up a single or recurring payment in an online bill payment system with a processing date within the calendar month displayed. Thus, the present invention takes into account future bill payments in generating projected balances. In one embodiment, the list is populated with this payment information based on real time and/or batch interface with a bill pay system associated with financial institution 103. Single payments are displayed if their processing date falls within the time window being displayed. Recurring payments are displayed if any instance of the payment has a processing date that falls within the time window being displayed.

Some online banking websites allow a user to request repeating payment reminders that are generally not paid until the user requests that they be sent. In one embodiment, such reminders are displayed as transaction reminders rather than as transactions. In one embodiment, report generation module 106 takes such reminders into account when determining projected balances, although the transactions themselves are not processed until approved by user 112.

In one embodiment, items also appear in monthly bills and deposits report 307 if user 112 has set up a single or recurring reminder for a manual transaction (a transaction that is paid outside of the online bill payment system such as paper check or biller website), and that transaction has a processing date in the calendar month being displayed. In one embodiment, user 112 can add such transactions through an “Add Transactions” screen, described in more detail below. For such transactions, the transaction amount affects the “Projected Balance” displayed. In one embodiment, reminders for a single payment are displayed when the payment's processing date falls within the window displayed. Reminders for a repeating payment are displayed when any instance of the payment falls within the window displayed.

In one embodiment, items also appear in monthly bills and deposits report 307 if they represent electronically presented bills, such as those received by email or by other electronic means. Such items can automatically be added to monthly bills and deposits report 307. If a corresponding item already appears in monthly bills and deposits report 307, and if any details of the listed item differ from the information received electronically, in one embodiment the existing item is updated to reflect the information received electronically. Thus, if user 112 previously entered an estimated amount for a bill, the record is updated to reflect the actual amount when the bill is electronically received or otherwise input.

In one embodiment, Biller Direct transactions are automatically added to monthly bills and deposits report 307, or (if a corresponding item already appears in monthly bills and deposits report 307) will update the scheduled amount of the transaction. Biller Direct transactions are transactions that user 112 initiates by visiting a website associated with the biller.

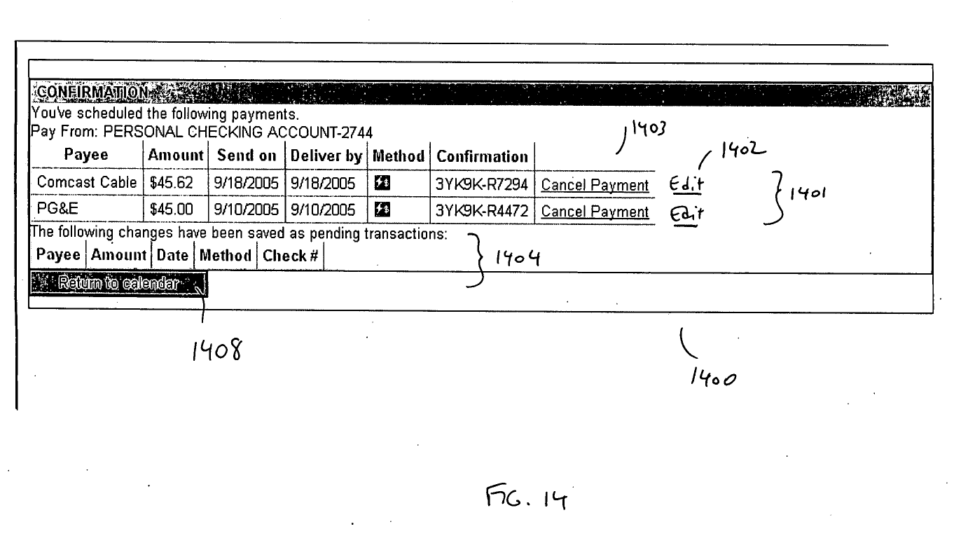

Monthly bills and deposits report 307 includes several items of information for each listed item. Paid indicator 314 indicates whether the item has been paid. If paid, a checkmark is shown. If not yet paid, an unchecked box is shown. The user can check the checkbox, enter an amount in field 318 and a payment date in field 319, and then click on Make Payments button 315 to automatically initiate payments for the checked items. In the case of manually entered items, user 112 can check the checkbox when he or she makes payment via paper check or biller website, or alternative method. In one embodiment, such payments are processed using well known bill-paying systems and methods. In one embodiment, clicking on Make Payments button 315 causes confirmation screen 1400 (FIG. 14) to be displayed.

In one embodiment, unpaid items are shown in boldface to further distinguish them from paid items. Save changes button 316 saves any entered changes and refreshes monthly bills and deposits report 307 to reflect the changes. Add a monthly bill or deposit button 317 navigates to an add transaction screen for user entry of transaction information.

Payee 308 for each transaction is shown. Method of payment 309 is also shown, and can include a check number (for manual checks), an icon indicating electronic payment, or other descriptor. Amount 310 is shown; for unpaid bills, a field 318 is provided so as to allow user 112 to enter or change the amount to be paid.

In one embodiment, date 311 is the anticipated or actual date that the transaction will clear at financial institution 103. If the current date is past the displayed date 311 and the item has not yet cleared, the transaction moves to be displayed on the current date, but the date 311 is maintained until the item clears. For unpaid items, field 319 is shown, to allow a user to enter a payment date. In one embodiment, button 320 provides access to graphical interface element for entering the payment date.

In one embodiment, for upcoming bills, user 112 can change the date via field 319 or the dollar amount via field 318 until the item is marked as in-process, paid, or posted. In response to user-entered changes to date and/or dollar amount, calendar 301 is updated. If applicable, projected balances 302 are also updated.

In one embodiment, status 312 indicates whether the item is posted, overdue, in process, scheduled, or the like. Unpaid items that are not yet due and have not yet been scheduled show a blank status 312. “Scheduled” means the item has been scheduled through online bill pay or manually, but it is not yet in process. “In-Process” means payment has been initiated by the bill payment engine. “Posted” means payment has cleared user's 112 account, and has been reconciled to the projected transaction.

In one embodiment, column 313 provides additional links, commands, and/or other information. For example, edit link 321 allows user 112 to edit the transaction by navigating to a transaction detail screen. Cancel payment link 322 allows user 112 to cancel a payment before it takes place, by navigating to a cancel transaction confirmation screen.

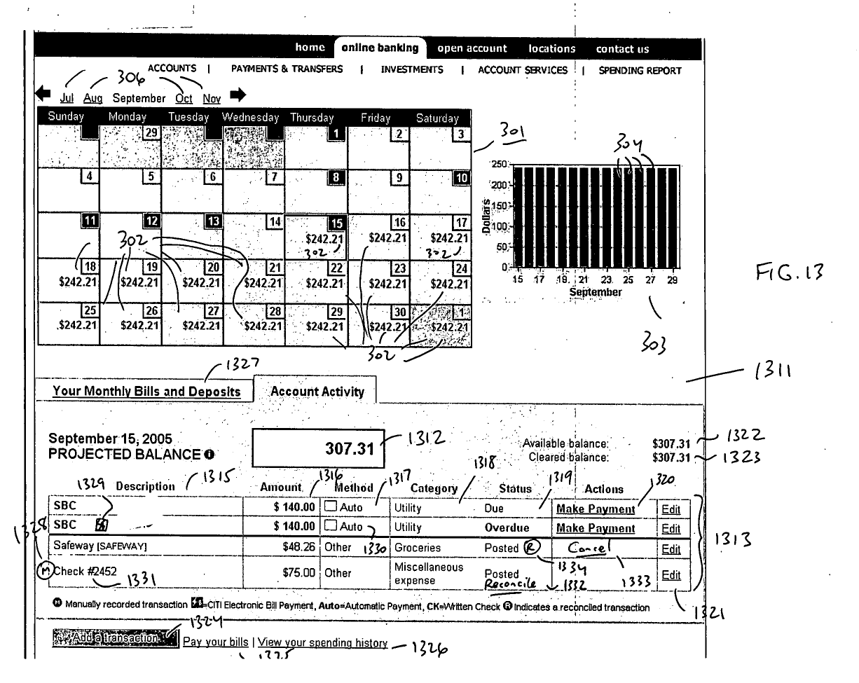

In one embodiment, account activity tab 323 provides access to account activity screen 1311, described below in connection with FIG. 13.

In one embodiment, bills and deposits report 307 is presented as a scrolling list, so there is no limit to the number of items that can be included.

Report 300 may also optionally include a display (not shown) of any or all of posted balance (including transactions from financial institution 103), available balance (amount available for the user to withdraw as of today's date), and projected balance (taking into account user-entered data 111 and/or data extracted from electronic bills 109 and/or other data 109A).

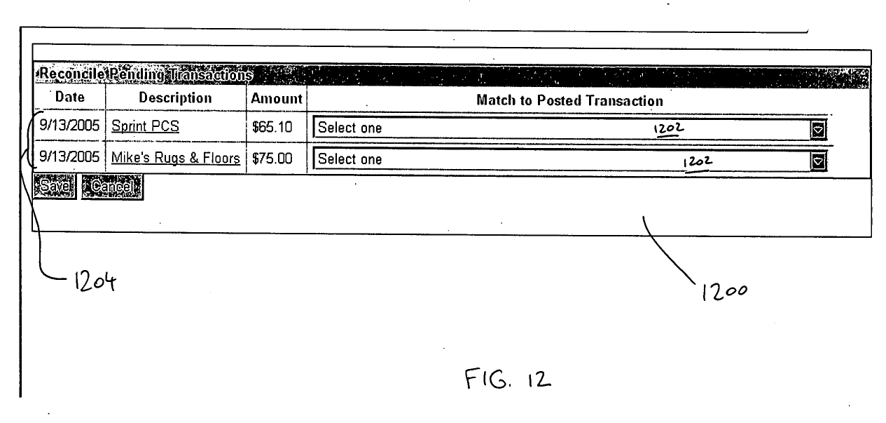

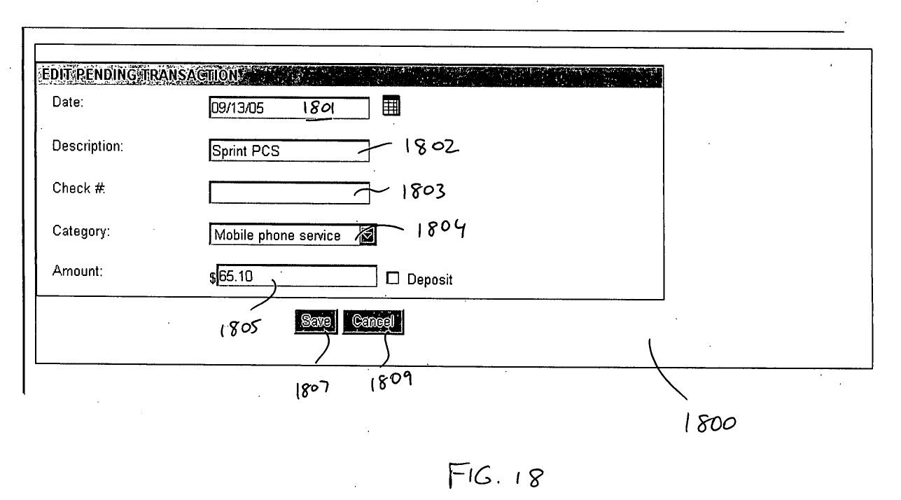

Referring now to FIG. 13, there is shown an example of an account activity screen 1311 for viewing and managing transactions associated with a particular day (or other time period). Screen 1311 includes in-process, projected, posted and reconciled transactions. Projected balance 1312 is shown, along with available balance 1322 and cleared balance 1323. A list 1313 of transactions is shown. In one embodiment, account activity screen 1311 provides a view into a single day's activity. For each transaction, information is shown including: description 1315, amount 1316, method of payment 1317, category 1318, and status 1319 (overdue, in process, or the like). A reconcile link 1332 can be provided to allow navigation to screen 1200 (FIG. 12) for reconciling user-entered transactions (and/or other transactions not previously known to or initiated by financial institution 103) with transactions received from financial institution 103), as well as action links (including a make payment link 1320 that navigates to a payment screen, or a cancel link 1333 that navigates to a cancellation confirmation screen and cancels the listed transaction), and edit link 1321 for navigating to screen 1800 (FIG. 18) for editing the transaction.

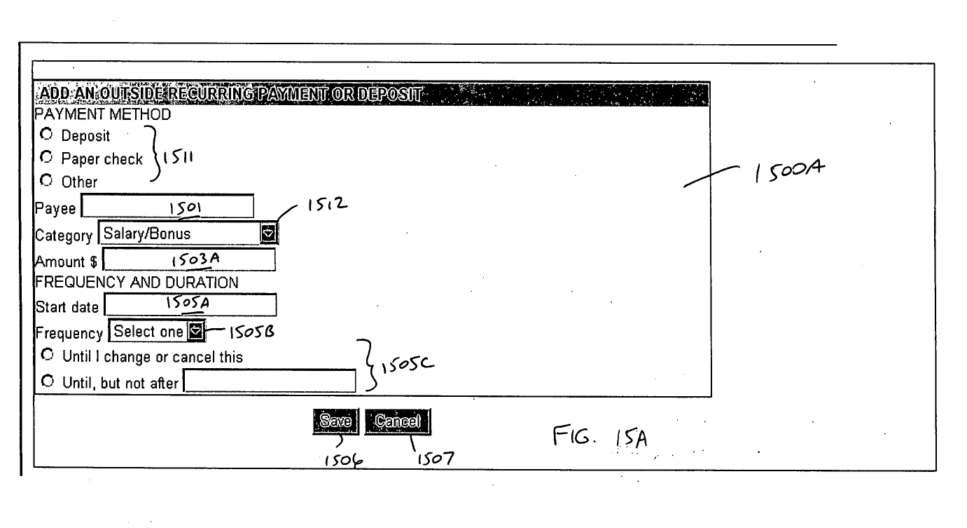

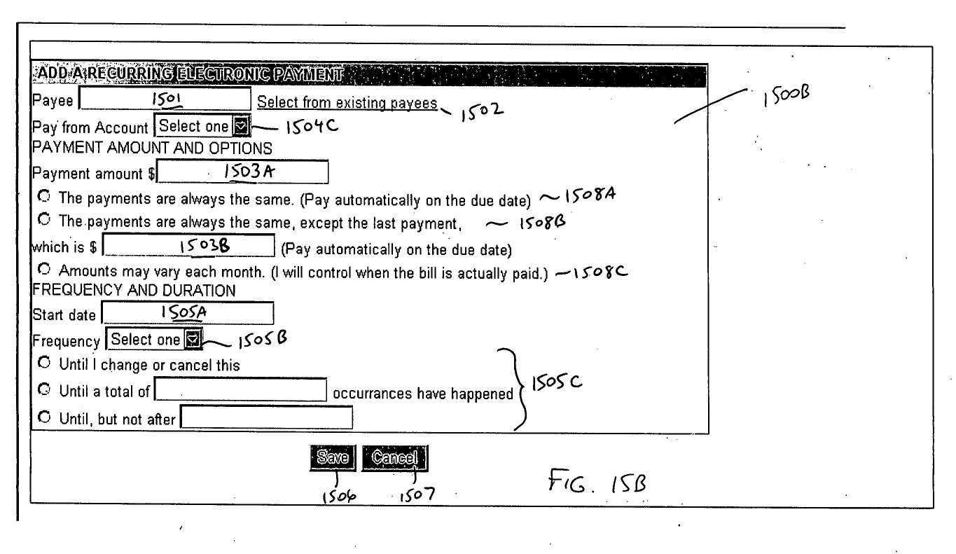

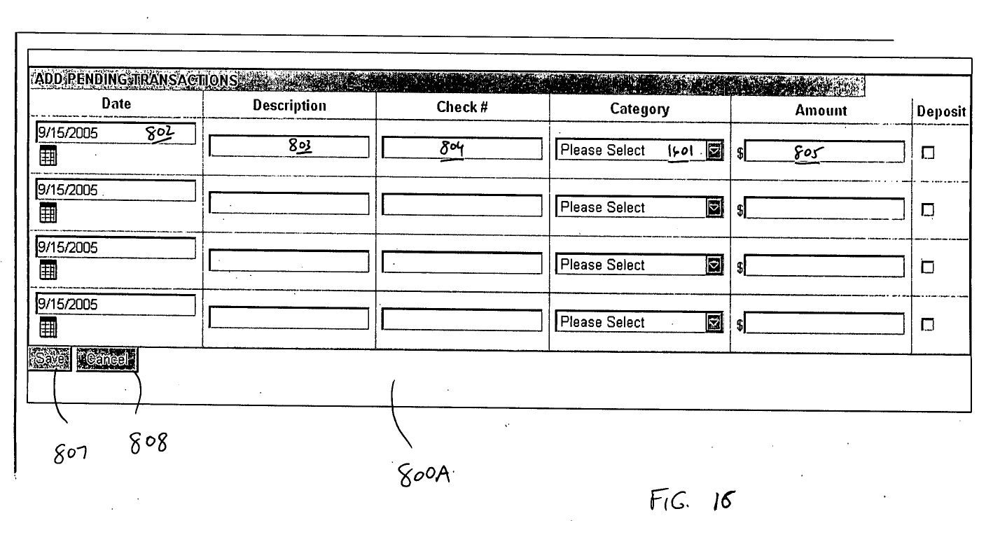

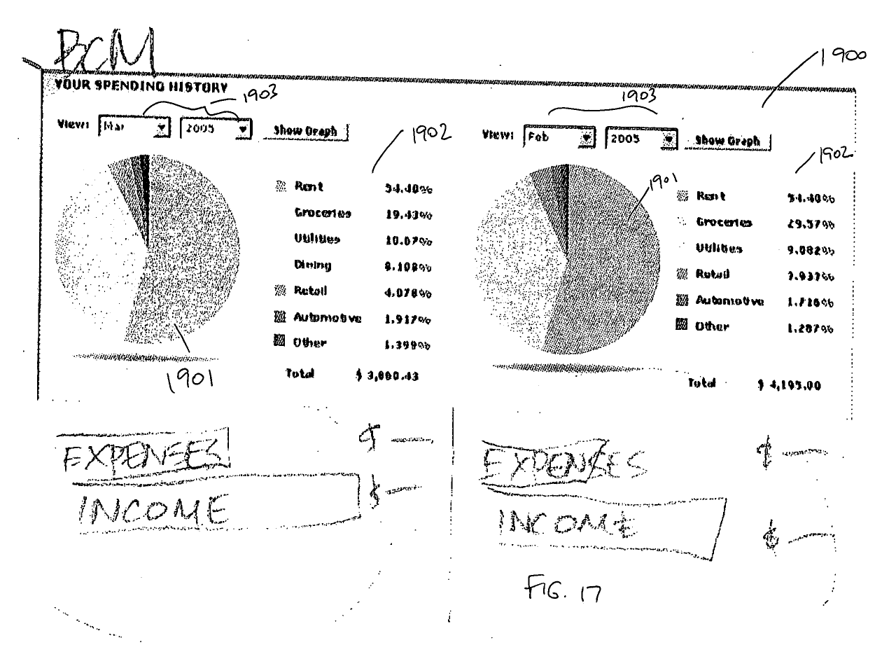

Add transaction button 1324 navigates to add pending transactions screen 800A, 1500 or 1500B (FIGS. 16, 15a, and 15b 6) or for adding new user-entered transactions. Pay your bills link 1325 navigates to a screen for initiating electronic bill payment. View your spending history link 1326 navigates to screen 1900 (FIG. 17) for selecting, configuring, and viewing reports showing historical spending.

Monthly bills and deposits tab 1327 causes monthly bills and reports report 307 to be displayed, as described above in connection with FIG. 3.

Various icons indicate status and other information for transactions. These include, for example, manually recorded transaction indicator 1328, electronic bill payment indicator 1329, written check indicator 1331, automatic payment indicator 1330, and reconciled transaction indicator 1334.

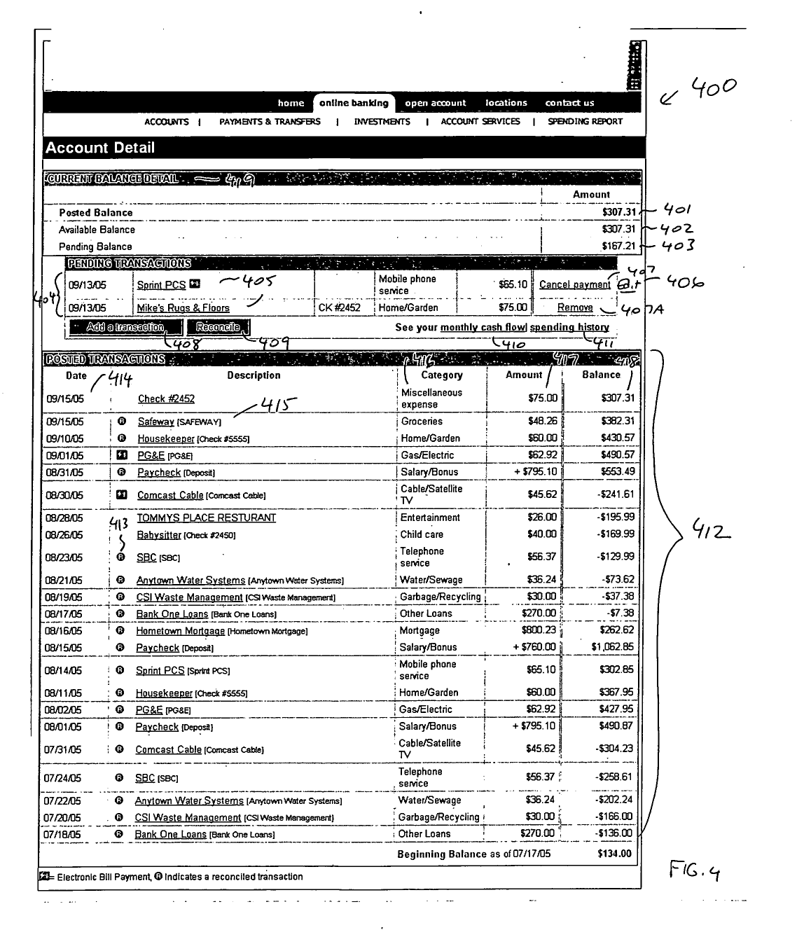

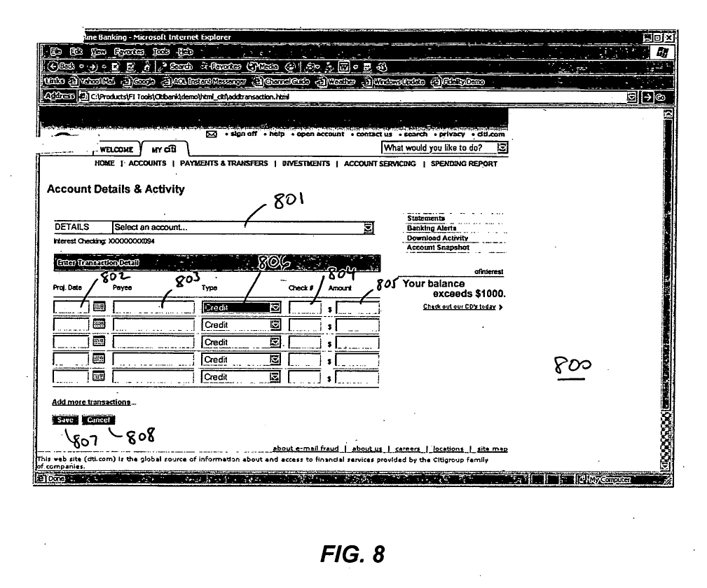

Referring now to FIG. 8, there is shown an example of add pending transactions screen 800 for entering user-entered data 111. In one embodiment, add pending transactions screen 800 is displayed when user clicks on add a transaction button 1324 in screen 1311 (FIG. 13) or add a transaction button 408 in account detail screen 400 (FIG. 4). User 112 selects an account using menu 801, and then enters transaction details for any number of transactions and/or bills. User 112 can enter a projected date in field 802, payee in field 803, check number in field 804, and amount in field 805. User 112 can select a type of transaction (credit, withdrawal, bill payment, deposit, or the like) via menu 806. Clicking on save button 807 causes the entered transactions and/or bills to be saved. Cancel button 808 causes input screen 800 to be dismissed without saving entered data. Referring also to FIG. 16, there is shown another example of input screen 800A for entering user-entered data 111. Here, category menu 1601 allows user 112 to select a category for the transaction being entered.

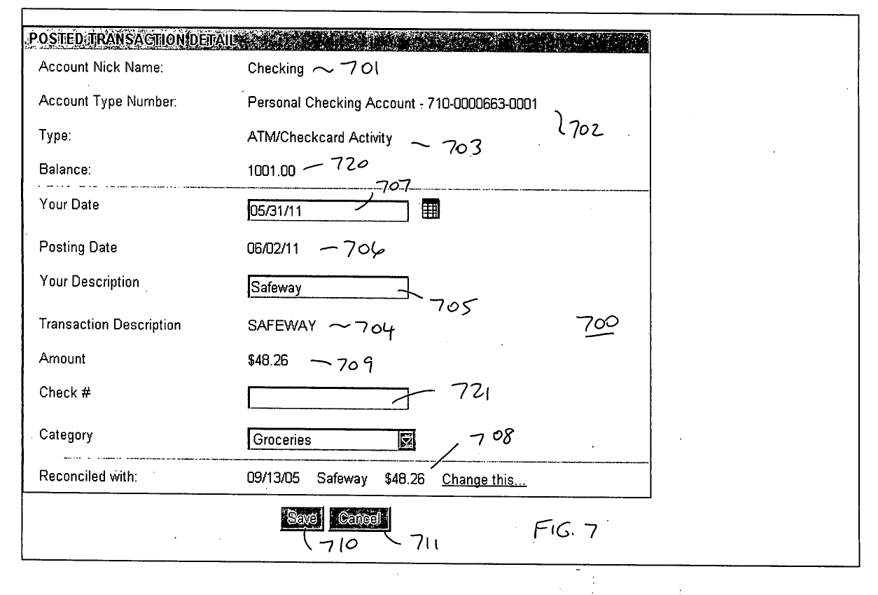

Referring now to FIG. 7, there is shown an example of a transaction detail screen 700 for reviewing details of user-entered transactions 111. In one embodiment, user 112 accesses transaction detail screen 700 by clicking on edit button 321 in report 301, or by clicking on description 415 in account detail report 400. Various items of information for a transaction are shown including: an account nickname 701, account type and number 702, type of transaction 703, description 704, nickname for description 705, posting date 706, user-entered transaction date 707, FI transaction to which this transaction is matched 708, amount 709, balance 720, and user-entered check number 721. Any or all of these items can be editable by the user, depending on the current status of the transaction. For example, a user can change an amount but not if the transaction has already been processed. Also, a user can specify a different matching FI transaction by selected from menu 708. Save button 710 saves changes; cancel button 711 dismisses transaction detail screen 700 without saving changes.

Referring now to FIG. 14, there is shown an example of confirmation screen 1400 for viewing scheduled payments and user-entered items that the user has indicated should be paid. In one embodiment, confirmation screen 1400 is displayed when user 112 clicks on make payments button 315 in screen 300 (FIG. 3). Scheduled payments 1401 are shown, along with links for editing 1402 and canceling 1403 each payment 1401. In one embodiment, user-entered transactions can also be shown in area 1404, with method menu (not shown) for specifying a method for payment and check # field (not shown) for entering a check number. Return to calendar button 1408 navigates to calendar 301.

Referring now to FIG. 15B, there is shown an example of a screen 1500B for adding recurring electronic payments. In one embodiment, add a recurring payment screen 1500B is displayed when user 112 clicks on add a monthly bill or deposit button 317 in screen 300 (FIG. 3). User 112 can enter a payee name in payee field 1501, or can click on payee link 1502 to select from existing payees. User 112 can enter a fixed amount in field 1503A, and/or an amount for a last payment 1503B, and/or can specify that amounts are variable. In one embodiment, radio button 1508A indicates amounts that stay the same, radio button 1508B indicates amounts that stay the same except the last payment, and radio button 1508C indicates variable amounts. User 112 can also specify start date 1505A, frequency 1505B, and stop conditions 1505C. Save button 1506 saves the recurring transaction; cancel button 1507 dismisses add a recurring payment screen 1500 without saving.

Referring now to FIG. 15A, there is shown an example of a screen 1500A for adding recurring payments or deposits that were not set up through the financial institution's online bill pay system. The user can select a payment method 1511, and can enter information such as payee 1501, category 1512, amount 1503A, start date 1505A, frequency 1505B, and stop conditions 1505C. Save button 1506 and cancel button 1507 are also provided.

Referring now to FIG. 12, there is shown an example of reconcile screen 1200 that is used for manual matching of user-entered transactions (and/or other transactions not previously known to or initiated by financial institution 103) with transactions from financial institution 103. In one embodiment, reconcile screen 1200 is displayed when user 112 clicks on reconcile button 409 in account detail screen 400 (FIG. 4). For each listed user-entered transaction 1204, user 112 can select a financial institution 103 transaction from menu 1202. In one embodiment, matching screen 1200 is presented only for transactions 1204 that cannot be matched automatically; in another embodiment, matching screen 1200 is presented for all unmatched transactions.

Calendar Display

Calendar 301 includes projected account balances 302. In one embodiment, projected account balances 302 take into account posted transaction balance (account balance 115 from financial institution's 103 real-time or batch posting system, optionally including transaction data 104a, b) plus any outstanding items (including payments and/or deposits) that the end user has initiated or entered, were initiated on the end user's behalf, but have not yet posted at financial institution 103. Projected account balances 302 are calculated for each relevant date as the available balance+projected (unreconciled) transactions. In one embodiment, the projected account balance 302 is shown on the current calendar date and future dates displayed to show balance reflecting scheduled, in-process transactions, as well as any future dates where the user has initiated a transaction. In another embodiment, the projected account balance 302 is shown on all dates currently displayed.

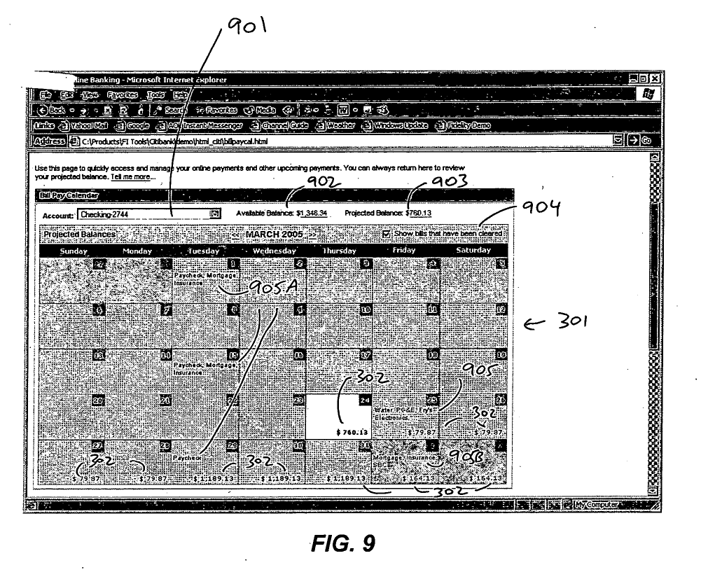

In one embodiment, calendar 301 also includes posted and/or projected transactions. For example, as shown in FIG. 9, payee names 905A, 905B can be shown for posted and/or projected transactions. Projected transactions are transactions that have been scheduled by user 112 and are not yet in-process, and have not yet been reconciled. These include, for example: single online bill payments, instance(s) of a recurring online bill payment, scheduled online payment that requires user approval to begin processing, single payment reminders, and instance(s) of a recurring payment reminder. A recurring payment reminder is a repeating transaction that user 112 has configured to remind user 112 to pay a bill on a regular basis.

Projected transactions are displayed on calendar 301, in whatever format is appropriate. For example, payee name 905B can be shown on the projected date. Other information can also be shown instead of or in addition to payee name 905B, such as amount, status, or the like. Such information can be shown directly in calendar 301, or can be accessible by causing a cursor to hover over the date, or clicking on the displayed information, or by clicking on the calendar date or by some other means. In one embodiment, if the transaction is a manual payment, and user 112 has not indicated that he or she has made payment, and “overdue” indicator is shown within calendar 301, and the transaction is displayed as a projected transaction on the current date until it is cleared.

Posted transactions are displayed on calendar 301, for example as a payee name 905A shown on the projected date. There include transactions reported as posted from financial institution 103. Other information can also be shown instead of or in addition to payee name 905A, such as amount, status, or the like. Such information can be shown directly in calendar 301, or can be accessible by causing a cursor to hover over the date, or clicking on the displayed information, by clicking on the date in the cell, or by some other means. In one embodiment, color-coding or some other visual indicator is used to distinguish projected transactions from posted transactions.

In one embodiment, clicking on a displayed payee name 905A, B initiates a look-up of all payments made to the specified payee for an established historical window of time. The window of time can be user-configurable, or configurable by financial institution 103.

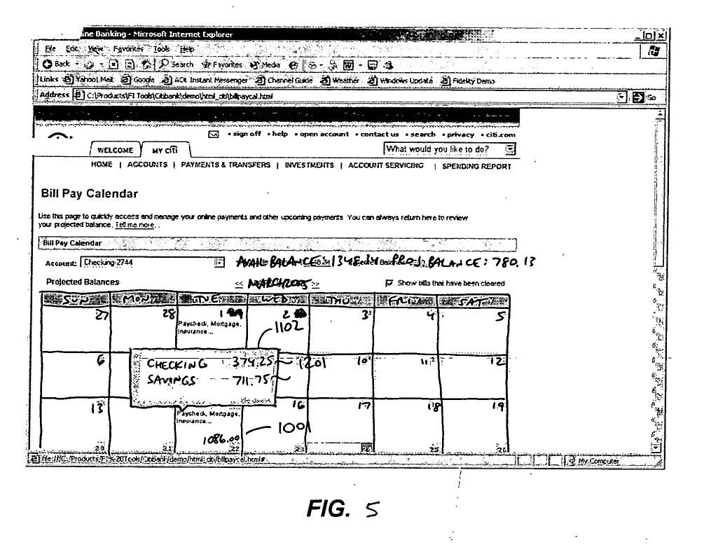

As described above, FIG. 3 depicts an example of calendar 301 within the context of report 300 that includes other elements. Calendar 301 can also be shown on its own. Referring now to FIGS. 9 through 11 and 5 through 6, there are shown additional variations on calendar 301 that may be displayed according to various embodiments of the present invention. As shown in FIG. 9, user 112 can select which account to display from popup menu 901 and can see available balance 902 and projected balance 903 for the selected account. Optionally, in addition to showing account balances for various dates, calendar 301 can also show payee names 905A, B and/or other information for particular transactions or bills. Examples are shown in FIG. 9. Checkbox 904 allows user 112 to specify whether these items should include bills that have been cleared.

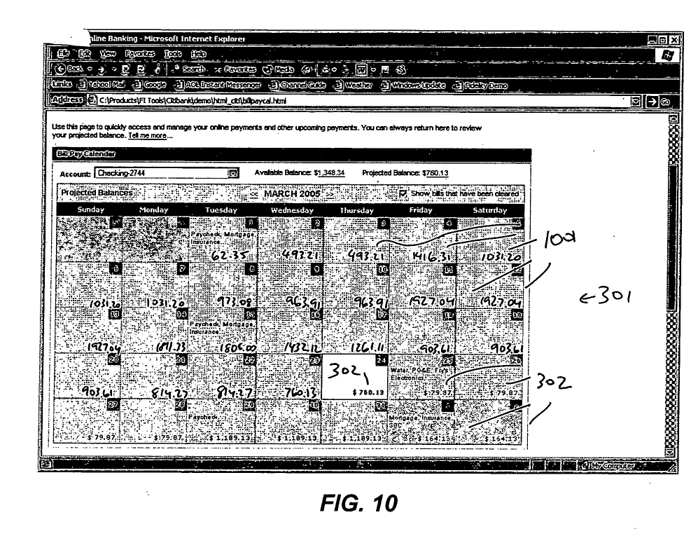

Referring now to FIG. 10, there is shown an example where calendar 301 generated by the present invention includes account balances for dates in the past 1001 as well as the present date of Mar. 24, 2005. Projected account balances 302 are also shown, as described above.

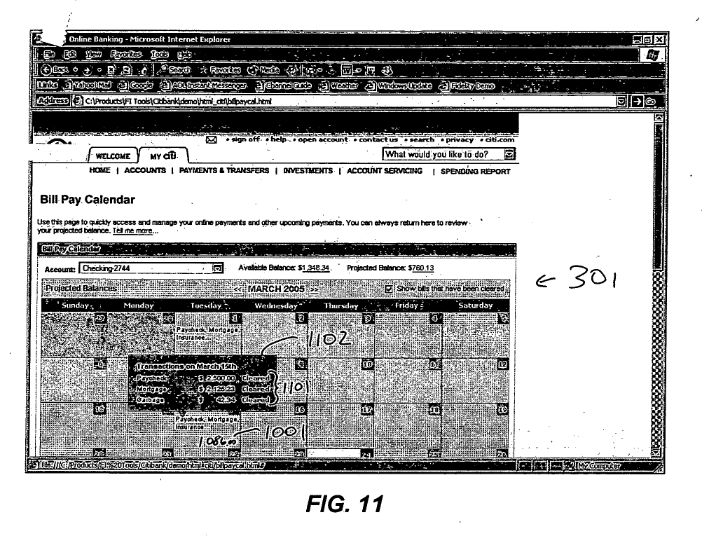

In one embodiment, user 112 can obtain more detailed information regarding an account balance for a date, whether past, present, or future, by clicking on the displayed account balance or by causing an on-screen cursor to hover over the account balance. Referring now to FIG. 11, there is shown an example where calendar 301 shows a balance 1001 within a date, and displays additional information 1101 (such as transaction information for that date) in a ToolTip-type box 1102 when the user causes an on-screen cursor to hover over the balance or when the user clicks on the balance. In one embodiment, each account balance 1101 (and/or projected account balance 302, if shown) is a link that, when clicked, takes the user to a web page or other display of additional information related to the account. In another embodiment, user can click on account balance 1101 (and/or projected account balance 302) to be taken to account activity tab 323 for the selected date.

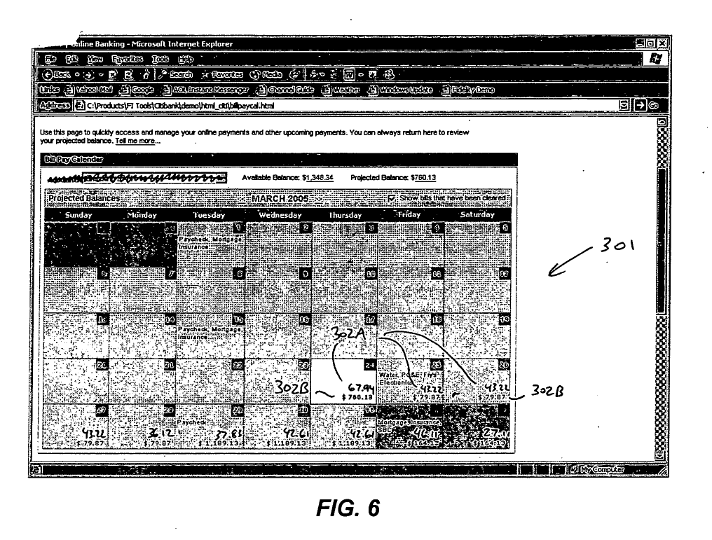

In one embodiment, if user 112 has more than one account, calendar 301 shows more than one balance 301A, 302B for a date, as shown in FIG. 6. Balances 301A, 302B can be listed in different colors or using other visually distinguishing characteristics, and a legend can be provided (not shown) so as to provide user 112 with a way to distinguish one balance 301A, 301B from another.

In one embodiment, as shown in FIG. 5, if user 112 has more than one account, calendar 301 shows a single balance 1001 (or projected balance 302) that includes all accounts, but displays individual account balances 1201 in ToolTip-type box 1102 that is shown when the user causes an on-screen cursor to hover over balance 1001 or when the user clicks on balance 1001. In an alternative embodiment, a separate calendar 301 is provided for each account; these multiple calendars can be displayed concurrently or singly in response to user selection.

In one embodiment, calendar 301 only shows a value for dates when the account balance has changed; in another embodiment, values are shown for each date whether or not there has been a change.

Calendar 301 can take any form, including a standard calendar-month view, a rolling calendar view (showing a number of weeks, such as 1 week in the past and 3 weeks in the future, in calendar format), a weekly view (showing a single week), or the like. In one embodiment, user 112 can specify the format of calendar 301; in another embodiment, the FI selects the form of the calendar; in another embodiment, the format is determined based on the number of transactions, available on-screen space within the display window, and/or other factors.

One skilled in the art will recognize that calendar 301 including account balances can be provided in other contexts as well. For example, a financial software application or accounting application or another device can display calendar 301 within its user interface, to show a series of account balances for various dates. Account balances can include past balances, present balance, and/or future balances, alone or in any combination. Account balance data can come from local sources, online sources, user-entered data, projections, estimates, or any combination thereof. One skilled in the art will recognize that the invention is not limited to the particular implementation of calendar 301 described herein, but includes any system, method, or computer program product or hand-held device where a calendar is displayed or printed that includes a series of account balances. Such implementations include, but are not limited to, personal computer software, websites, web applications, kiosk applications, PDA applications, cell phone applications, consumer devices, and the like.

Account Detail

Referring now to FIG. 4, there is shown a screen shot depicting an example of an account detail page 400 provided by the present invention according to one embodiment. As with report 300, account detail page 400 can be displayed in the context of a web page, or within a personal financial software application or accounting application, or handheld device, or the like. In one embodiment, account detail page 400 is a mechanism by which the user can see and enter transactions, review detailed history and projections for his or her account, and access other functionality. One skilled in the art will recognize that account detail page 400 can have many different layouts and arrangements other than those pictured here, and can omit or include any combination of the various features and elements described herein.

Current balance detail section 419 shows posted balance (including transactions from financial institution 103), available balance (provided by the FI and indicating the amount the user can withdraw to for a given day), and projected balance (taking into account user-entered data 111 and/or data extracted from electronic bills 109 and/or other data 109A such as electronic bill payment, presented bills, and the like).

Transactions list 404 shows a number of pending (not yet posted) transactions 405. The user can edit a transaction by clicking on edit link 406 (which in one embodiment navigates to edit pending transaction screen 1800 as shown in FIG. 18), or can delete (cancel) a transaction by clicking on cancel link 407, or can add a new transaction by clicking on add a transaction button 408. Remove link 407A removes the transaction from the screen without canceling or deleting it. In one embodiment, clicking on add a transaction button 408 causes add pending transactions screen 800 or 800A to be displayed (FIGS. 8 and 16). Reconcile button 409 activates a process whereby user-entered data (and/or other transactions not previously known to or initiated by financial institution 103) is reconciled with data from financial institution 103; in one embodiment, reconcile button 409 causes screen 1200 (FIG. 12) to be displayed. Monthly cash flow link 410 provides access to calendar 301. Spending history link 411 provides access to a report showing historical spending, such as report 1900 (FIG. 17).

Posted transactions report 412 includes a list of posted transactions. Reconciled transactions are indicated by a symbol 413. For each posted transaction, there is shown a date 414, description 415. In one embodiment, description 415 includes one or both of a) a FI-provided description, and b) a user-entered description. In one embodiment, description 415 may also be a link to a more detailed description of the transaction, category 416, amount 417, and running balance 418.

Referring now to FIG. 18, there is shown an example of edit pending transaction screen 1800 that is shown when user clicks on edit link 406 in account detail screen 400 (FIG. 4). Here, the user can change values in date field 1801, description field 1802, check # field 1803, category menu 1804, and amount field 1805. In one embodiment, the user can also specify an existing transaction with which the pending transaction should be reconciled, via a menu (not shown). Save button 1807 saves the transaction; cancel button 1809 dismisses edit pending transaction screen 1800 without saving changes. In one embodiment a delete button (not shown) can also be provided.

Referring now to FIG. 17, there is shown an example of a report 1900 that can be accessed by clicking on spending history link 411 of account detail screen 400 (FIG. 4) or from other locations on the FI website. Report 1900 includes two pie charts 1901, each showing relative spending in various categories. User 112 can specify a time period for each pie chart 1901 via menus 1903. Tabular information 1902 is also shown for each pie chart 1901. One skilled in the art will recognize that any type of report, whether graphical, tabular, or some combination thereof, can be provided.

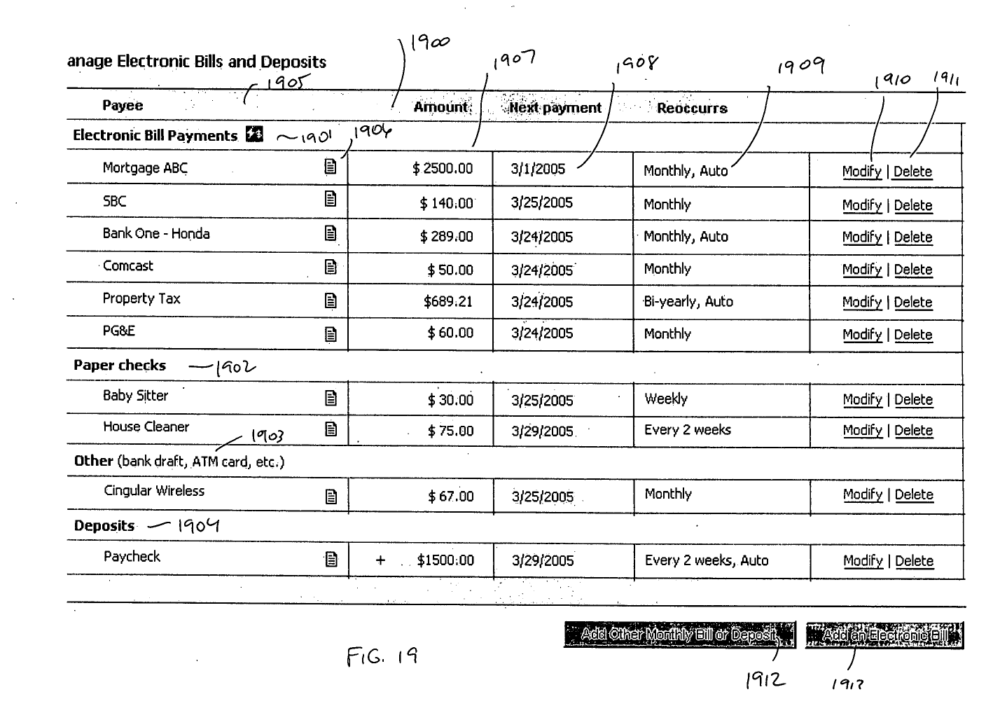

Referring now to FIG. 19, there is shown an example of a manage electronic bills and deposits screen 1900. Here, the user can see electronic bill payments 1905, paper checks 1902 that have been entered by user 112 or uploaded from personal financial software on his or her machine, other transactions 1903 and deposits 1904. Icon 1906 allows user 112 to access a particular transaction. For each transactions, the following information is displayed: amount 1907, next payment 1908, and frequency 1909. User 112 can click Modify 1910 to modify the transaction or Delete 1911 to delete it. Add Other Monthly Bill or Deposit button 1912 allows user 112 to add a new transaction of such type, and Add an Electronic Bill button 1913 allows user 112 to add an electronic bill.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for generating an account balance for display, comprising:
obtaining account data from a financial institution, the account data describing a user's account;
obtaining additional transaction data for the user's account, describing at least one additional transaction from a source other than the financial institution:
generating, at a server remotely located with respect to the user, a projected account balance for a future date based on the obtained account data and the obtained additional transaction data; and
transmitting the projected account balance to a computing device accessible to the user, for display thereon.

2. The method of claim 1, wherein obtaining additional transaction data for the user's account comprises obtaining user-entered transaction data.

3. The method of claim 1, wherein obtaining additional transaction data for the user's account comprises receiving user input via a web page.

4. The method of claim 1, wherein obtaining additional transaction data for the user's account comprises receiving data uploaded from a computing device accessible to the user.

5. The method of claim 4, wherein receiving data uploaded from a computing device accessible to the user comprises receiving data previously input by the user in a financial software application running at the computing device.

6. The method of claim 1, wherein obtaining additional transaction data for the user's account comprises receiving data from an electronic biller.

7. The method of claim 1, further comprising:
receiving information describing at least one transaction processed by a financial institution for the user's account;
and wherein generating a projected account balance comprises generating a projected account balance for a future date based on the obtained account data, the received information, and the obtained additional transaction data.

8. The method of claim 1, further comprising:
receiving information describing at least one transaction not processed by a financial institution for the user's account;
and wherein generating a projected account balance comprises generating a projected account balance for a future date based on the obtained account data, the received information, and the obtained additional transaction data.

9. The method of claim 1, further comprising outputting the projected account balance within a calendar.

10. The method of claim 1, further comprising outputting the projected account balance comprises outputting within a list of pending transactions.

11. The method of claim 1, further comprising outputting at least two projected account balances, each projected account balance being associated with a date.

12. The method of claim 11, further comprising outputting the at least two projected account balances within a calendar.

13. The method of claim 1, wherein:
obtaining additional transaction data for the user's account comprises obtaining additional transaction data describing at least one transaction not yet entered at the financial institution.

14. The method of claim 1, wherein:
obtaining additional transaction data for the user's account comprises obtaining additional transaction data describing at least one transaction not yet entered at a posted transactions system associated with the financial institution.

15. The method of claim 1, further comprising:
receiving transaction data from a financial institution; and
reconciling the received transaction data with the at least one additional transaction described in the additional transaction data.

16. A method for managing bill payments, comprising:
receiving an account balance for a user's account;
receiving electronic bill pay data;
generating a projected account balance for a future date based on the received account balance and the received electronic bill pay data; and
outputting the projected account balance.

17. The method of claim 16, wherein receiving electronic bill pay data comprises receiving user input, via a web page, describing at least one bill.

18. The method of claim 17, further comprising:
receiving bill payment data from a financial institution; and
reconciling the received bill payment data with the user input describing at least one bill.

19. The method of claim 16, further comprising:
receiving information describing at least one bank-processed transaction for the user's account;
and wherein generating a projected account balance comprises generating a projected account balance for a future date based on the received account balance, the received information, and the received electronic bill pay data.

20. The method of claim 16, wherein outputting the projected account balance comprises outputting the projected account balance within a calendar.

21. The method of claim 16, wherein outputting the projected account balance comprises outputting at least two projected account balances, each projected account balance being associated with a date.

22. The method of claim 21, wherein outputting the at least two projected account balances comprises outputting the at least two projected account balances within a calendar.

23. The method of claim 21, wherein receiving an account balance comprises receiving a posted and available account balance.

24. The method of claim 16, wherein receiving an account balance comprises receiving the account balance from a financial institution.

25. The method of claim 16, wherein receiving an account balance comprises receiving the account balance via the Internet from a financial institution.

26. The method of claim 16, wherein outputting the projected account balance comprises displaying a report within a web page.

27. The method of claim 16, wherein receiving electronic bill pay data comprises receiving user input describing at least one bill that has not yet been paid.

28. The method of claim 16, wherein receiving electronic bill pay data comprises receiving user input entered via a personal financial software application.

29. The method of claim 16, wherein receiving electronic bill pay data comprises receiving user input entered via a website.

30. The method of claim 16, wherein receiving electronic bill pay data comprises receiving data via bill presentment.

31. A method for managing bill payments, comprising:
receiving an account balance for a user's account;
receiving an electronically-presented bill;
generating a projected account balance for a future date based on the received account balance and the received bill; and
outputting the projected account balance.

32. The method of claim 31, further comprising:
receiving user input, via a web page, describing at least one additional transaction for the user's account;
and wherein generating a projected account balance for a future date comprises generating a projected account balance for a future date based on the received account balance, the received user input, and the received bill

33. The method of claim 31, further comprising:
extracting at least a bill amount from the electronically-presented bill;
and wherein generating a projected account balance for a future date comprises generating a projected account balance for a future date based on the received account balance and the extracted bill amount.

34. A computer program product for generating an account balance for display, comprising:
a computer-readable medium; and
computer program code, encoded on the medium, for:
obtaining account data from a financial institution, the account data describing a user's account;
obtaining additional transaction data for the user's account, describing at least one additional transaction for the user's account;
generating, at a server remotely located with respect to the user, a projected account balance for a future date based on the obtained account data and the obtained additional transaction data; and
transmitting the projected account balance to a computing device accessible to the user, for display thereon.

35. The method of claim 34, wherein the computer program code for obtaining additional transaction data for the user's account comprises computer program code for obtaining user-entered transaction data.

36. The computer program product of claim 34, wherein the computer program code for obtaining additional transaction data for the user's account comprises computer program code for receiving user input via a web page.

37. The computer program product of claim 34, wherein the computer program code for obtaining additional transaction data for the user's account comprises computer program code for receiving data uploaded from a computing device accessible to the user.

38. The computer program product of claim 37, wherein the computer program code for receiving data uploaded from a computing device accessible to the user comprises computer program code for receiving data previously input by the user in a financial software application running at the computing device.

39. The computer program product of claim 34, further comprising computer program code for:
receiving information describing at least one transaction processed by a financial institution for the user's account;
and wherein the computer program code for generating a projected account balance comprises computer program code for generating a projected account balance for a future date based on the obtained account data, the received information, and the obtained additional transaction data.

40. The computer program product of claim 34, further comprising computer program code for:
receiving information describing at least one transaction not processed by a financial institution for the user's account;
and wherein the computer program code for generating a projected account balance comprises computer program code for generating a projected account balance for a future date based on the obtained account data, the received information, and the obtained additional transaction data.

41. The computer program product of claim 34, further comprising computer program code for outputting the projected account balance within a calendar.

42. The computer program product of claim 34, further comprising computer program code for outputting the projected account balance comprises outputting within a list of pending transactions.

43. The computer program product of claim 34, further comprising computer program code for outputting at least two projected account balances, each projected account balance being associated with a date.

44. The computer program product of claim 43, further comprising computer program code for outputting the at least two projected account balances within a calendar.

45. The computer program product of claim 34, wherein:
the computer program code for obtaining additional transaction data for the user's account comprises computer program code for obtaining additional transaction data describing at least one transaction not yet entered at the financial institution.

46. The computer program product of claim 34, wherein:
the computer program code for obtaining additional transaction data for the user's account comprises computer program code for obtaining additional transaction data describing at least one transaction not yet entered at a posted transactions system associated with the financial institution.

47. The computer program product of claim 34, further comprising computer program code for:
receiving transaction data from a financial institution; and
reconciling the received transaction data with the at least one additional transaction described in the additional transaction data.

48. A computer program product for managing bill payments, comprising:
a computer-readable medium; and
computer program code, encoded on the medium, for:
receiving an account balance for a user's account;
receiving electronic bill pay data;
generating a projected account balance for a future date based on the received account balance and the received electronic bill pay data; and
outputting the projected account balance.

49. The computer program product of claim 48, wherein the computer program code for receiving electronic bill pay data comprises computer program code for receiving user input, via a web page, describing at least one bill.

50. The computer program product of claim 49, further comprising computer program code for:
receiving bill payment data from a financial institution; and
reconciling the received bill payment data with the user input describing at least one bill.

51. The computer program product of claim 48, further comprising computer program code for:
receiving information describing at least one bank-processed transaction for the user's account;
and wherein the computer program code for generating a projected account balance comprises computer program code for generating a projected account balance for a future date based on the received account balance, the received information, and the received electronic bill pay data.

52. The computer program product of claim 48, wherein the computer program code for outputting the projected account balance comprises computer program code for outputting the projected account balance within a calendar.

53. The computer program product of claim 48, wherein the computer program code for outputting the projected account balance comprises computer program code for outputting at least two projected account balances, each projected account balance being associated with a date.

54. The computer program product of claim 53, wherein the computer program code for outputting the at least two projected account balances comprises computer program code for outputting the at least two projected account balances within a calendar.

55. The computer program product of claim 53, wherein the computer program code for receiving an account balance comprises computer program code for receiving a posted and available account balance.

56. The computer program product of claim 48, wherein the computer program code for receiving an account balance comprises computer program code for receiving the account balance from a financial institution.

57. The computer program product of claim 48, wherein the computer program code for receiving an account balance comprises computer program code for receiving the account balance via the Internet from a financial institution.

58. The computer program product of claim 48, wherein the computer program code for outputting the projected account balance comprises computer program code for displaying a report within a web page.

59. The computer program product of claim 48, wherein the computer program code for receiving electronic bill pay data comprises computer program code for receiving user input describing at least one bill that has not yet been paid.

60. The computer program product of claim 48, wherein the computer program code for receiving electronic bill pay data comprises computer program code for receiving user input entered via a personal financial software application.

61. The computer program product of claim 48, wherein the computer program code for receiving electronic bill pay data comprises computer program code for receiving user input entered via a website.

62. The computer program product of claim 48, wherein the computer program code for receiving electronic bill pay data comprises computer program code for receiving data via bill presentment.

63. A computer program product for managing bill payments, comprising:
a computer-readable medium; and
computer program code, encoded on the medium, for:
receiving an account balance for a user's account;
receiving an electronically-presented bill;
generating a projected account balance for a future date based on the received account balance and the received bill; and
outputting the projected account balance.

64. The computer program product of claim 63, further comprising computer program code for:
receiving user input, via a web page, describing at least one additional transaction for the user's account;
and wherein the computer program code for generating a projected account balance for a future date comprises computer program code for generating a projected account balance for a future date based on the received account balance, the received user input, and the received bill.

65. The computer program product of claim 63, further comprising computer program code for:
extracting at least a bill amount from the electronically-presented bill;
and wherein the computer program code for generating a projected account balance for a future date comprises computer program code for generating a projected account balance for a future date based on the received account balance and the extracted bill amount.

66. A system for generating an account balance for display, comprising, at an online banking web server:
a financial institution interface for obtaining account data from a financial institution, the account data describing a user's account;
a client communication interface, for obtaining from a client machine additional transaction data for the user's account, describing at least one additional transaction for the user's account; and
a report generation module, for generating a projected account balance for a future date based on the obtained account data and the obtained additional transaction data;
wherein the client communication interface transmits the projected account balance to the client machine, for display thereon.

67. The system of claim 66, wherein the additional transaction data comprises user-entered transaction data.

68. The system of claim 67, wherein the client communication interface obtains user-entered transaction data for the user's account by receiving user input via a web page.

69. The system of claim 67, wherein the client communication interface obtains user-entered transaction data for the user's account by receiving data uploaded from a computing device accessible to the user.

70. The system of claim 69, wherein the client communication interface receives data previously input by the user in a financial software application running at the computing device.

71. The system of claim 66, wherein:
the financial institution interface receives information describing at least one transaction processed by a financial institution for the user's account; and
the report generation module generates a projected account balance for a future date based on the obtained account data, the received information, and the obtained additional transaction data.

72. The system of claim 66, wherein:
the client communication interface receives information describing at least one transaction not processed by a financial institution for the user's account; and
the report generation module generates a projected account balance for a future date based on the obtained account data, the received information, and the obtained additional transaction data.

73. The system of claim 66, wherein the client communication interface transmits a representation of the projected account balance within a calendar for display at the client machine.

74. The system of claim 66, wherein the client communication interface transmits a representation of the projected account balance within a list of pending transactions for display at the client machine.

75. The system of claim 66, wherein the client communication interface transmits a representation comprising at least two projected account balances, each projected account balance being associated with a date, for display at the client machine.

76. The system of claim 75, wherein the representation comprising the at least two projected account balances within a calendar.

77. The system of claim 66, wherein:
the client communication interface obtains additional transaction data describing at least one transaction not yet entered at the financial institution.

78. The system of claim 66, wherein:
the client communication interface obtains additional transaction data describing at least one transaction not yet entered at a posted transactions system associated with the financial institution.

79. The system of claim 66, wherein the financial institution interface receives transaction data from a financial institution, the system further comprising:
a reconciliation module, for reconciling the received transaction data with the at least one additional transaction described in the additional transaction data.

80. A system for managing bill payments, comprising:
a financial institution interface for receiving an account balance for a user's account;
a client communication interface, for receiving electronic bill pay data; and
a report generation module, for generating a projected account balance for a future date based on the received account balance and the received user input;
wherein the client communication interface transmits the projected account balance to a client machine, for display thereon.

81. The method of claim 80, wherein the client communication interface receives user input, via a web page, describing at least one bill.

82. The system of claim 81, wherein the financial institution interface receives bill payment data from a financial institution, the system further comprising:
a reconciliation module, for reconciling the received bill payment data with the user input describing at least one bill.

83. The system of claim 80, wherein:
the financial institution interface receives information describing at least one bank-processed transaction for the user's account; and
the report generation module generates a projected account balance for a future date based on the received account balance, the received information, and the received electronic bill pay data.

84. The system of claim 80, wherein the client communication interface transmits a representation of the projected account balance within a calendar.

85. The system of claim 80, wherein the client communication interface transmits a representation of at least two projected account balances, each projected account balance being associated with a date.

86. The system of claim 85, the representation of at least two projected account balances comprises a representation of the at least two projected account balances within a calendar.

87. The system of claim 85, wherein the financial institution interface receives a posted and available account balance.

88. The system of claim 80, wherein the financial institution interface receives the account balance from a financial institution.

89. The system of claim 80, wherein the financial institution interface receives the account balance via the Internet from a financial institution.

90. The system of claim 80, wherein the client communication interface transmits a representation of a report within a web page.

91. The system of claim 80, wherein the electronic bill pay data comprises user input describing at least one bill that has not yet been paid.

92. The system of claim 80, wherein the electronic bill pay data comprises user input entered via a personal financial software application.

93. The system of claim 80, wherein the electronic bill pay data comprises user input entered via a website.

94. The system of claim 80, wherein the electronic bill pay data comprises data received via bill presentment.

95. A system for managing bill payments, comprising:
a financial institution interface for receiving an account balance for a user's account;
a scraper, for receiving and processing an electronically-presented bill; and
a report generation module, for generating a projected account balance for a future date based on the received account balance and the received bill; and
wherein the client communication interface transmits the projected account balance to a client machine, for display thereon.

96. The system of claim 95, further comprising:
a client communication interface, for receiving user input, entered via a web page, describing at least one additional transaction for the user's account;
and wherein the report generation module generates a projected account balance for a future date based on the received account balance, the received user input, and the received bill

97. The system of claim 95, wherein:
the scraper extracts at least a bill amount from the electronically-presented bill; and
and the report generation module generates a projected account balance for a future date based on the received account balance and the extracted bill amount.
